(19) United States
(12) Patent Application Publication
(10) Pub. No.: US 2022/0290612 A1
(43) Pub. Date: Sep. 15, 2022

(54) FUEL SUPPLY SYSTEM AND FUEL SUPPLY METHOD

(71) Applicant: HONDA MOTOR CO., LTD., Tokyo (JP)

(72) Inventor: Akira Ota, Wako-shi (JP)

(21) Appl. No.: 17/666,594

(22) Filed: Feb. 8, 2022

(30) Foreign Application Priority Data
Mar. 12, 2021 (JP) 2021-040368

(51) Int. Cl. F02C 7/22; F04C 2/08

(52) U.S. Cl. CPC F02C 7/22; F04C 2/084; F04C 2240/40; F05D 2220/32; F05D 2240/35

(57) ABSTRACT

What is provided is a fuel supply system that includes a fuel gear pump that is driven by an electric motor and sends fuel in a fuel tank to a fuel nozzle that supplies fuel to the combustor, a controller that controls a rotational speed of the electric motor, and the flow rate measurer that measures the flow rate of fuel discharged from the fuel gear pump. When the difference between the fuel flow rate actually discharged from the electric motor and a target value of the flow rate is equal to or greater than a first threshold value with respect to the target value, the controller adjusts the rotational speed of the electric motor so that the measured value of the flow rate of the fuel discharged from the fuel gear pump approaches the target value.

### CROSS-REFERENCE TO RELATED APPLICATION

Priority is claimed on Japanese Patent Application No. 2021-040368, filed Mar. 12, 2021, the content of which is incorporated herein by reference.

### BACKGROUND

### Field of the Invention

The present invention relates to a fuel supply system and a fuel supply method.

### Description of Related Art

In the related art, although the flow rate of fuel discharged from a fuel gear pump is measured to control a fuel supply amount to a gas turbine engine, there is a case in which discharge amount characteristics of the fuel gear pump may change due to an operating environment or deterioration over time. When such a characteristics change occurs, because it is not possible to accurately measure the flow rate of the fuel, there is a likelihood that an appropriate amount of fuel will not be able to be supplied to the engine. In order to solve such a problem, a technique for supplying the fuel discharged from the gear pump to the fuel nozzle of the gas turbine engine via a parallel flow path of a fixed orifice and a pressing valve, and detecting an actual flow rate of the fuel passing through the parallel flow path based on a differential pressure before and after the parallel flow path has been developed (Japanese Unexamined Patent Application, First Publication No. 2013-231406: Patent Document 1).

### SUMMARY

However, in the technique of Patent Document 1, because it was necessary to provide a parallel flow path via the fixed orifice, the pressing valve, or the like, there was a likelihood that the fuel supply system would have been complicated and the costs high.

The present invention has been made in consideration of such circumstances, and an object thereof is to provide a fuel supply system and a fuel supply method capable of accurately measuring the flow rate of fuel supplied to a combustion chamber via the fuel gear pump in a gas turbine engine with a simpler configuration.

The fuel supply system and fuel supply method according to the present invention have adopted the following configurations.

(1): A fuel supply system according to an aspect of the present invention includes a fuel gear pump that is driven by an electric motor and sends fuel in a fuel tank to a fuel nozzle that supplies the fuel to a combustor, and a control device. The control device includes a storage device that stores a program, and a hardware processor. The hardware processor executes the program stored in the storage device to execute a process of controlling a rotational speed of the electric motor, and measure the flow rate of the fuel to be discharged from the fuel gear pump. When the difference between the fuel flow rate actually discharged from the electric motor and a target value of the flow rate is equal to or greater than a first threshold value with respect to the target value in the control process, a rotational speed of the electric motor is adjusted so that a measured value of the flow rate of the fuel discharged from the fuel gear pump approaches the target value.

(2): In the aspect of above (1), the target value may be set for each rotational speed based on past discharge flow rate characteristics of the fuel gear pump, and the hardware processor may acquire the target value of the flow rate with respect to the current rotational speed based on the current rotational speed of the electric motor and flow rate characteristics information indicating the past discharge flow rate characteristics.

(3): In the aspect of above (1), the hardware processor may measure a fuel pressure, which is a pressure on an upstream side of the fuel nozzle in a fuel supply line, and measure a combustor internal pressure, which is a pressure inside the combustor, and the hardware processor may calculate the flow rate of the fuel discharged from the fuel gear pump, based on the difference between the fuel pressure and the combustor internal pressure.

(4): In the aspect of above (1), when a differential pressure between the current fuel pressure and the past fuel pressure is equal to or greater than a second threshold value, the hardware processor may determine that the fuel nozzle has deteriorated.

(5): In the aspect of above (4), the hardware processor may acquire a value of the past fuel pressure, based on the current rotational speed of the electric motor and pressure characteristic information indicating a relationship between the rotational speed of the electric motor and the discharge pressure in the past.

(6): In the aspect of above (1), the hardware processor may measure the flow rate of the fuel, by a flow meter installed on the upstream side of a manifold that sends the fuel discharged from the fuel gear pump to each of the fuel nozzles in a fuel supply line.

(7): A fuel supply method according to an aspect of the present invention is a fuel supply method of sending fuel in a fuel tank to a fuel nozzle that supplies the fuel to a combustor by a fuel gear pump, in which an electric motor drives the fuel gear pump, a control device measures the flow rate of the fuel discharged from the fuel gear pump, and when the difference between the fuel flow rate actually discharged from the electric motor and a target value of the flow rate is equal to or greater than a first threshold value with respect to the target value, the control device adjusts a rotational speed of the electric motor so that a measured value of the flow rate of the fuel discharged from the fuel gear pump approaches the target value.

According to (1) to (7), in the fuel supply system in which fuel in the fuel tank is sent by the gear pump to the fuel nozzle that supplies fuel to the combustor, the gear pump is driven by the electric motor, and the flow rate of the fuel discharged from the gear pump is measured. When the difference between the fuel flow rate actually discharged from the electric motor and the target value of the flow rate is equal to or greater than the first threshold value with respect to the target value, the rotational speed of the electric motor is adjusted so that the measured value of the flow rate of the fuel discharged from the fuel gear pump approaches the target value. Accordingly, it is possible to accurately measure the flow rate of the fuel to be supplied to the combustion chamber via the fuel gear pump in the gas turbine engine with a simpler configuration.

### BRIEF DESCRIPTION OF THE DRAWINGS

FIG. 1 is a diagram showing a configuration example of a fuel supply system of a first embodiment.

FIG. 2 is a block diagram showing a configuration example of a control device according to the first embodiment.

FIG. 3 is a diagram showing a method by which a motor controller in the first embodiment adjusts a rotational speed of an electric motor.

FIG. 4 is a flowchart showing an example of flow of a process related to special control in the first embodiment.

FIG. 5 is a diagram showing a configuration example of a fuel supply system of a second embodiment.

FIG. 6 is a block diagram showing a configuration example of a control device according to the second embodiment.

FIG. 7 is a flowchart showing an example of the flow of a process related to special control in the second embodiment.

### DETAILED DESCRIPTION OF THE INVENTION

Hereinafter, embodiments of the fuel supply system and the fuel supply method of the present invention will be described with reference to the drawings. The fuel supply system of the embodiment is mounted on an aircraft that obtains propulsion by, for example, a gas turbine engine. This gas turbine engine is, for example, a turboshaft engine. The turboshaft engine includes, for example, an intake port, a compressor, a combustion chamber, a turbine, and the like. The compressor compresses the intake air sucked from an intake port. The combustion chamber is disposed downstream of the compressor and burns a gas that is a mixture of compressed air and fuel to generate a combustion gas. The turbine is connected to the compressor and rotates integrally with the compressor by the force of the combustion gas. When an output shaft of the turbine rotates due to the above rotation, a generator connected to the output shaft of the turbine operates. The aircraft can fly by rotating a propeller with the electric power generated by the generator. As used throughout this disclosure, the singular forms “a,” “an,” and “the” include plural reference unless the context clearly dictates otherwise.

### First Embodiment

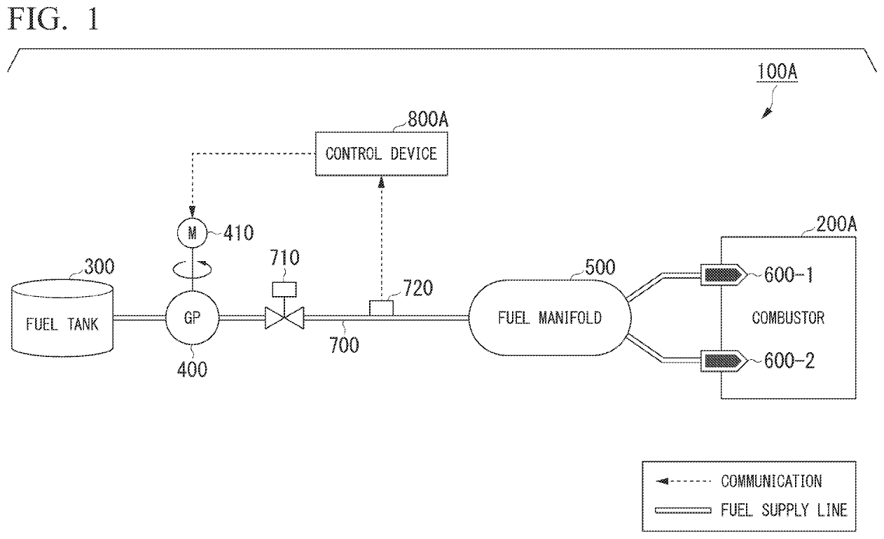

FIG. 1 is a diagram showing a configuration example of a fuel supply system 100A of the first embodiment. For example, the fuel supply system 100A is a system that adjusts the amount of fuel supplied to the combustor of the gas turbine engine. The fuel supply system 100A includes a combustor 200A, a fuel tank 300, a fuel gear pump 400, a fuel manifold 500, a fuel nozzle 600, a fuel supply line 700, and a control device 800A. The fuel tank 300, the fuel gear pump 400, the fuel manifold 500, and the fuel nozzle 600 are connected in the order of the fuel tank 300, the fuel gear pump 400, the fuel manifold 500, and the fuel nozzle 600 by the fuel supply line 700, and supply the fuel stored in the fuel tank 300 to the combustor 200A by sending the fuel in a connecting direction thereof. Hereinafter, in the fuel supply line 700, a side closer to the fuel tank 300 which is a fuel supply source is referred to as an upstream side, and a side far from the fuel tank 300 is referred to as a downstream side.

The combustor 200A is one of constituent elements of a gas turbine engine and is a device that burns fuel with compressed air. In FIG. 1, for the sake of simplicity, the compressor that compresses the air and sends it to the combustor 200A is omitted. The combustor 200A is provided with a fuel nozzle 600 for supplying the fuel into the combustion chamber. Although FIG. 1 shows an example in which two fuel nozzles 600-1 and 600-2 are installed in the combustor 200A for the sake of simplicity, the number of fuel nozzles 600 installed in the combustor 200A is not limited to two. The number of fuel nozzles 600 installed in the combustor 200A may be one or three or more.

The fuel tank 300 is a container for storing fuel. The fuel gear pump 400 is a pump that draws fuel from the fuel tank 300 and sends it to the fuel manifold 500. In general, the power of the fuel gear pump provided in a gas turbine engine is often transmitted from a drive system of the gas turbine engine equipped with the fuel gear pump, whereas the fuel gear pump 400 in the present embodiment is driven by the electric motor 410. The rotational speed of the electric motor 410 can be controlled to be an arbitrary rotational speed by an inverter, and is adjusted to a predetermined rotational speed according to the fuel flow rate by the control device 800A. The fuel manifold 500 is a pipeline that branches to distribute the fuel supplied to the combustor 200A to the plurality of fuel nozzles 600.

A shutoff valve 710 and a fuel flow meter 720 are installed on the downstream side of the fuel gear pump 400 and on the upstream side of the fuel manifold 500 in the fuel supply line 700. The shutoff valve 710 is a safety valve for shutting off the fuel supply to the combustor 200A in an emergency. The fuel flow meter 720 is a device capable of measuring the flow rate of fuel flowing through the fuel supply line 700. When the fuel flow meter 720 measures the flow rate of the fuel flowing through the fuel supply line 700, the fuel flow meter 720 notifies the control device 800A of the measured value. The control device 800A corrects the rotational speed of the electric motor 410 based on the measured value of the fuel flow rate notified from the fuel flow meter 720.

In the fuel supply system 100A configured in this way, the fuel gear pump 400 is driven by the electric motor 410 whose rotational speed can be adjusted, and the rotational speed of the electric motor 410 can be corrected based on the measured value of the fuel flow rate supplied to the combustor 200A. With such a configuration, because it is not necessary to use a fuel flow metering unit having a complicated structure for measuring the fuel flow rate, and it is not necessary to transmit the power of the fuel gear pump 400 from the drive system of the gas turbine engine, the configuration of the fuel supply system 100A can be simplified. Therefore, according to the fuel supply system 100A of the embodiment, it is possible to accurately measure the fuel flow rate without complicating the system configuration, and it is possible to realize a low-cost and highly accurate fuel supply system.

The fuel supply system 100A capable of achieving such an effect can be realized by the control device 800A having a function of controlling the rotational speed of the electric motor 410 based on the measured value of the fuel flow rate. Hereinafter, the configuration of the control device 800A having such a control function will be described in detail.

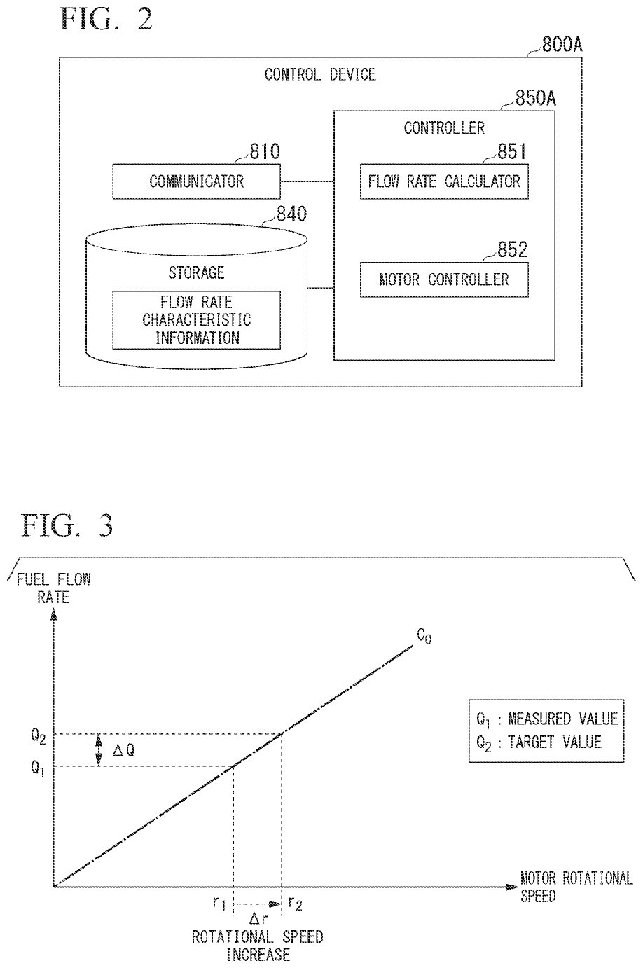

FIG. 2 is a block diagram showing a configuration example of the control device 800A according to the first embodiment. For example, the control device 800A is an Electronic Controller (ECU), and includes a communicator 810, a storage 840, and a controller 850A. Among these constituent elements, the controller 850A is realized by, for example, executing a program (software) through a hardware processor such as a Central Processing Unit (CPU). Some or all of these constituent elements may be realized by hardware (circuit including circuitry) such as a Large-Scale Integration (LSI), & Application Specific Integrated Circuit (ASIC), Field-Programmable Gate Array (FPGA), and Graphics Processing Unit (GPU), or may be realized by cooperation of software and hardware. The program may be stored in advance in a storage device (a storage device including a non-transient storage medium) such as a Hard Disk Drive (HDD) or a flash memory, or is stored in a detachable storage medium (non-transient storage medium) such as a DVD or a CD-ROM and may be installed by mounting the storage medium in a drive device.

The communicator 810 is a communication interface that connects the control device 800A to the electric motor 410 and the fuel flow meter 720 in a communicable manner. The control device 800A inputs a signal related to the flow rate of fuel (hereinafter referred to as a “flow rate signal”) from the fuel flow meter 720 via the communicator 810, and outputs a control signal for adjusting the rotational speed of the electric motor 410 to the electric motor 410 via the communicator 810. The control device 800A may be configured to include a separate communication interface for each of the electric motor 410 and the fuel flow meter 720.

The storage 840 is configured using a storage device such as an HDD or a flash memory. The storage 840 stores data of a program to be executed by the control device 800A, communication data transmitted and received to and from another device, and various information related to the operation of the control device 800A.

The controller 850A has a function of controlling the operation of the control device 800A. Here, the control function of the controller 850A includes a function of controlling the rotational speed of the electric motor 410 based on the measured value of the fuel flow rate. Specifically, the controller 850A includes, for example, the flow rate measurer 851 and a motor controller 852 as a configuration for realizing these functions.

The flow rate measurer 851 acquires the flow rate value of the fuel to be supplied to the combustor 200A based on the flow rate signal which is input via the communicator 810. The flow rate measurer 851 notifies the motor controller 852 of the acquired flow rate value as a measured value of the fuel flow rate.

The motor controller 852 compares a target value of the fuel flow rate set depending on the current situation of the gas turbine engine (hereinafter referred to as “own engine”) equipped with the control device 800A with an actual fuel flow rate measured by the flow rate measurer 851. When the difference between the target value and the measured value exceeds a predetermined first threshold value, the motor controller 852 adjusts the rotational speed of the electric motor 410 so that the actual fuel flow rate approaches the target value. Here, the adjustment function of the rotational speed performed by the motor controller 852 is a so-called auxiliary function that corrects the rotational speed determined depending on the state of the own engine.

Therefore, hereinafter, an operation of appropriately determining the rotational speed of the electric motor 410 depending on the state of the own engine, and controlling the electric motor 410 to obtain the determined rotational speed is referred to as a “normal control”, and an operation of adjusting the rotational speed of the electric motor 410 determined by a normal control as the above-mentioned auxiliary function is referred to as a “special control”. The motor controller 852 may be configured to perform both the normal control and the special control, and when the normal control is performed by another function, it may be configured to perform only the special control. Hereinafter, it is assumed that the motor controller 852 performs only the special control, and the normal control is performed by another function (not shown).

FIG. 3 is a diagram showing a method by which the motor controller 852 adjusts the rotational speed of the electric motor 410 by the special control. FIG. 3 is a diagram showing an example of a relationship between the rotational speed of the electric motor 410 and the flow rate of the fuel discharged from the fuel gear pump 400. For example, in FIG. 3, it is assumed that the electric motor 410 is driven at a rotational speed r₁ with the target value of the fuel flow rate as Q₂. This situation is a situation in which the target value Q₂ depending on the state of the own engine is determined by the normal control, and r₁ is determined as the rotational speed of the electric motor 410 required to realize the fuel flow rate of the determined target value Q₂.

However, in the situation shown in FIG. 3, the measured value of the actual fuel flow rate is Q₁ which is lower than the target value Q₂. Such a discrepancy between the target value and the measured value can occur when the discharge flow rate characteristics of the fuel gear pump 400 change due to factors such as temperature and aging deterioration. In a situation in which such a change in discharge flow rate characteristics occurs, it is not possible to accurately grasp the actual flow rate of fuel from the rotational speed. Therefore, there is a concern that an appropriate amount of fuel cannot be supplied to the combustor 200A by only measuring the fuel flow rate in the fuel gear pump 400.

Therefore, in the control device 800A of the present embodiment, the motor controller 852 can control the rotational speed of the electric motor 410 so that the actual fuel flow rate approaches the target value, by monitoring the difference between the measured value of the fuel flow rate and the target value, and performing the special control when the difference exceeds the first threshold value.

For example, in the example of FIG. 3, in a case where the fuel flow rate measured when the actual motor rotational speed is r is Q₁, and a difference ΔQ between the measured value Q₁ and the target value Q₂ is greater than the first threshold value Q_{TH} when the target value of the fuel flow rate at that time is Q₂, the motor controller 852 defines a current motor rotational speed r₁ assumed to give the measured value Q₁ in the discharge flow rate characteristics (for example, expressed by a straight line Co in FIG. 3) assumed regarding the target value Q₂, and defines the motor rotational speed r₂ assumed to give the target value Q₂. Further, the motor controller 852 corrects the difference between the motor rotational speeds r₁ and r₂ defined in this way, and increases the rotational speed of the electric motor 410 so that the measured value Q₁ approaches the target value Q₂. That is, the motor controller 852 brings the motor rotational speed closer to r+Δr by correcting the difference value Δr (=r₂−r₁) on the actual motor rotational speed r.

In this case, the motor controller 852 acquires the target value of the fuel flow rate assumed with respect to the current rotational speed of the motor, based on the information indicating the assumed discharge flow rate characteristics (hereinafter referred to as “flow rate characteristic information”) with respect to the target value of the fuel flow rate and the current motor rotational speed. The flow rate characteristic information shows the past discharge flow rate characteristics of the fuel gear pump 400, and is stored in advance in, for example, the storage 840. For example, the flow rate characteristic information may indicate the discharge flow rate characteristic at the past reference time point, or may be expressed by the statistical value of the discharge flow rate characteristics in the past predetermined period. In general, because the target value of the fuel flow rate is often determined based on the initial discharge flow rate characteristics of the fuel gear pump 400, the flow rate characteristic information in the present embodiment is supposed to be information indicating the initial discharge flow rate characteristics of the fuel gear pump 400. In this case, the flow rate characteristic information may be generated based on the information measured in the inspections and tests performed in the initial operation stage such as the engine shipment.

The operation of adjusting the rotational speed of the motor so that the actual fuel flow rate approaches the target value includes an operation of adjusting the rotational speed of the motor so that the actual fuel flow rate matches the target value. For example, the motor controller 852 may change the motor rotational speed so that the actual fuel flow rate follows the target value by a feedback control, or may change the motor rotational speed so that the actual fuel flow rate matches the target value by a feedforward control. When the target value of the fuel flow rate is updated in the process of increasing the motor rotational speed, the motor controller 852 may adjust the motor rotational speed so that the actual fuel flow rate approaches the updated target value. In this case, the motor controller 852 may be configured to terminate the special control when the difference between the updated target value and the actual fuel flow rate (measured value) is equal to or less than the first threshold value.

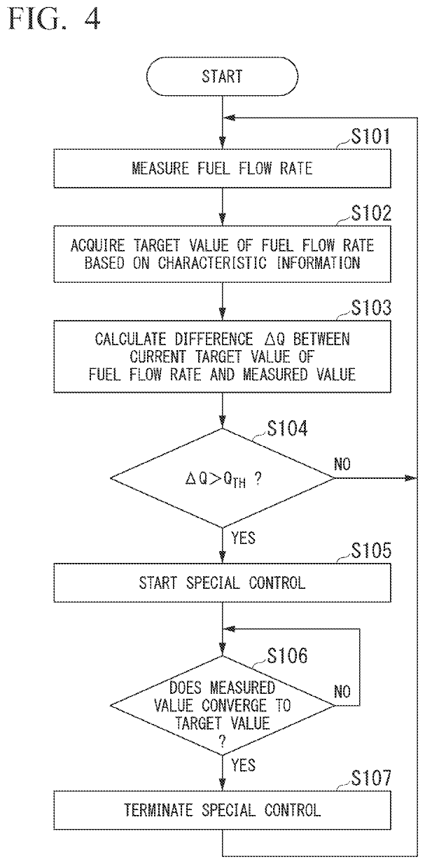

FIG. 4 is a flowchart showing an example of the flow of process related to the special control in the first embodiment. Here, a situation is assumed in which the gas turbine engine is in operation at the start time point of the flow and the fuel discharge flow rate by the fuel gear pump 400 is controlled by the normal control. In this situation, first, the flow rate measurer 851 measures the flow rate of the fuel flowing through the fuel supply line 700 based on the flow rate signal that is output from the fuel flow meter 720 (step S101). The flow rate measurer 851 notifies the motor controller 852 of the measured value of the fuel flow rate.

Subsequently, the motor controller 852 refers to the flow rate characteristic information stored in the storage 840, and acquires the target value of the fuel flow rate assumed for the current rotational speed of the electric motor 410 (step S102). Subsequently, the motor controller 852 calculates the difference ΔQ between the target value of the current fuel flow rate and the measured value of the fuel flow rate acquired in step S101 (step S103), and determines whether the calculated value of ΔQ exceeds a predetermined first threshold value Q_{TH} (step S104). Here, when it is determined that the value of ΔQ exceeds the first threshold value Q_{TH}, the motor controller 852 starts the special control of adjusting the rotational speed of the electric motor 410 so that the measured value of the fuel flow rate approaches the current target value (step S105). On the other hand, when it is determined in step S104 that the value of ΔQ does not exceed the first threshold value Q_{TH}, the motor controller 852 returns the process to step S101 and continues the control of the electric motor 410 by the normal control. During the implementation of the special control, the target value of the fuel flow rate may be fixed to the flow rate at the start time point of the special control, or may be changed at any time depending on a state change of the own engine or the like.

When the motor controller 852 starts the special control in step S105, it subsequently determines whether the measured value of the fuel flow rate converges to the target value (step S106). Convergence here means that the measured value becomes a value within the range of the tolerance from the target value. If it is determined that the measured value does not converge to the target value, the motor controller 852 repeatedly executes step S106 until it is determined that the measured value converges to the target value. On the other hand, when it is determined in step S106 that the measured value converges to the target value, the motor controller 852 terminates the special control (step S107) and returns the process to step S101.

In steps S106 and S107, the motor controller 852 may be configured to terminate the special control when the difference ΔQ between the measured value and the target value becomes equal to or less than a predetermined threshold value. In this case, the threshold value for determining the termination of the special control may be set to the same value as the first threshold value Q_{TH} when determining the start of the special control, or may be set to a value smaller than the first threshold value Q_{TH}.

The fuel supply system 100A of the first embodiment configured in this way sends the fuel in the fuel tank 300 to the fuel nozzle 600 that supplies fuel to the combustor 200A by the fuel gear pump 400. The fuel supply system 100A drives the fuel gear pump 400 by the electric motor 410, and measures the flow rate of the fuel discharged from the fuel gear pump 400. When the difference between the fuel flow rate actually discharged from the electric motor 410 and the target value with respect to the target value of the flow rate is equal to or more than a predetermined first threshold value, the fuel supply system 100A adjusts the rotational speed of the electric motor 410 so that the measured value of the flow rate of the fuel discharged from the fuel gear pump 400 approaches the target value. With such a configuration, the fuel supply system 100A of the embodiment can accurately measure the flow rate of the fuel to be supplied to the combustion chamber via the fuel gear pump in the gas turbine engine with a simpler configuration.

### Second Embodiment

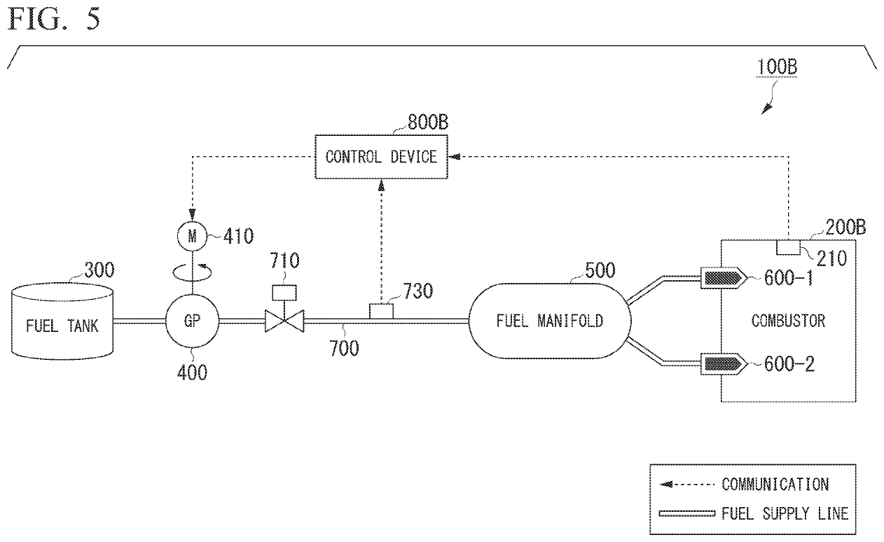

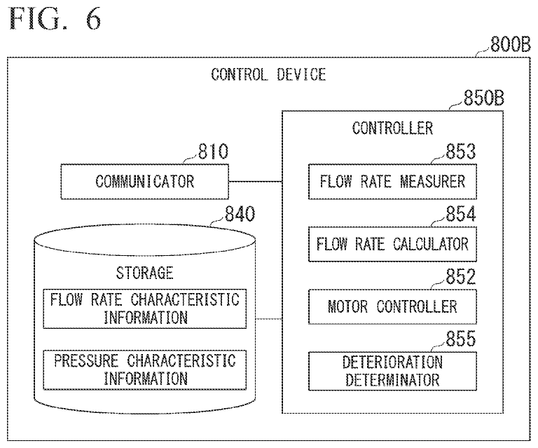

FIG. 5 is a diagram showing a configuration example of a fuel supply system 100B of the second embodiment. The fuel supply system 100B is different from the fuel supply system 100A of the first embodiment in that a combustor 200B is provided instead of the combustor 200A, a control device 800B is provided instead of the control device 800A, and a fuel pressure gauge 730 is provided instead of the fuel flow meter 720 of FIG. 1. The combustor 200B is different from the combustor 200A of the first embodiment in that it further includes a combustion pressure gauge 210. Other configurations of the fuel supply system 100B are the same as those of the fuel supply system 100A. Therefore, in FIG. 5, the same configurations as those of the fuel supply system 100A are designated by the same reference numerals as those in FIG. 1 and a description thereof will be omitted.

The combustion pressure gauge 210 is a pressure gauge that measures the pressure in the combustion chamber of the combustor 200B (hereinafter referred to as “combustor internal pressure”). The combustion pressure gauge 210 is installed at a position where the combustor internal pressure can be measured in the combustor 200B. The combustion pressure gauge 210 is communicably connected to the control device 800B, and outputs a signal regarding the combustor internal pressure to the control device 800B.

The fuel pressure gauge 730 is a pressure gauge that measures the pressure (hereinafter referred to as “fuel pressure”) of fuel flowing through the fuel supply line 700. The fuel pressure gauge 730 is installed on the downstream side of the fuel gear pump 400 and on the upstream side of the fuel manifold 500, similarly to the fuel flow meter 720 of the first embodiment. That is, the fuel pressure is the discharge pressure of the fuel gear pump 400. The fuel pressure gauge 730 is communicably connected to the control device 800B, and outputs a signal regarding the fuel pressure to the control device 800B.

The control device 800B is different from the control device 800A of the first embodiment in that the fuel flow rate value used for determining whether to perform the special control is calculated based on the measured value of the pressure.

FIG. 6 is a block diagram showing a configuration example of the control device 800B according to the second embodiment. The control device 800B is different from the control device 800A of the first embodiment in that a controller 850B is provided instead of the controller 850A. The controller 850B is different from the controller 850A of the first embodiment in that a pressure measurer 853 and the flow rate calculator 854 are provided instead of the flow rate measurer 851, and a deterioration determinator 855 is further provided. Other configurations of the control device 800B are the same as those of the control device 800A. Therefore, in FIG. 6, the same configurations as those of the control device 800A are designated by the same reference numerals as those in FIG. 2, and a description thereof will be omitted.

The pressure measurer 853 measures the combustor internal pressure based on the output signal of the combustion pressure gauge 210 that is input via the communicator 810. The pressure measurer 853 measures the fuel pressure based on the output signal of the fuel pressure gauge 730 that is input via the communicator 810. The pressure measurer 853 notifies the flow rate calculator 854 and the deterioration determinator 855 of the measured values of the combustor internal pressure and the fuel pressure.

The flow rate calculator 854 calculates the flow rate of the fuel that is supplied to the combustor 200B based on the measured values of the combustor internal pressure and the fuel pressure notified from the pressure measurer 853. For example, the flow rate calculator 854 can calculate the flow rate of the fuel that flows into the combustor 200B according to the following (1). The Equation (1) is obtained by converting an orifice equation of a mass flow rate into an equation of a volume flow rate. The combustor internal pressure can be replaced by the pressure of an outlet of the compressor that compresses the air and sends it to the combustor 200A. In this case, the fuel supply system 100B may include a pressure gauge that measures the compressor outlet pressure instead of the combustion pressure gauge 210.

$$\begin{matrix}[ Equation 1 ] & \\ Q = α A \sqrt{\frac{2 Δ p}{ρ}} & ( 1 )\end{matrix}$$

In Equation (1), Q represents the fuel flow rate, and Δp represents a differential pressure between the fuel pressure and the combustor internal pressure. ρ represents a fuel density, and A represents an area of the orifice that connects the fuel nozzle 600. α represents a dimensionless flow rate coefficient. The flow rate calculator 854 notifies the motor controller 852 of the calculated value of the fuel flow rate as a measured value of the fuel flow rate flowing through the fuel supply line 700. In the second embodiment, a combination of the pressure measurer 853 and the flow rate calculator 854 is an example of the “flow rate measurer”.

The deterioration determinator 855 determines whether the fuel nozzle 600 deteriorates based on the measured value of the fuel pressure. Specifically, when the difference between the value of the fuel pressure (hereinafter referred to as “reference pressure”) assumed for the current operating situation of the fuel gear pump 400 and the value of the actual fuel pressure (measured value) exceeds a predetermined second threshold value based on the past discharge pressure characteristics of the fuel gear pump 400, the deterioration determinator 855 determines that the fuel nozzle 600 deteriorates (for example, the fuel nozzle 600 is clogged). In this case, for example, the deterioration determinator 855 acquires the value of the reference pressure assumed for the current motor rotational speed, based on information indicating the past discharge pressure characteristics of the fuel gear pump 400 (hereinafter referred to as “pressure characteristic information”) and the current motor rotational speed. The pressure characteristic information of this case is information indicating a relationship between the rotational speed of the electric motor 410 and the discharge pressure of the fuel gear pump 400, and is stored in, for example, the storage 840 in advance.

For example, the pressure characteristic information may indicate the discharge pressure characteristics at the past reference time point, or may be expressed by the statistical value of the discharge pressure characteristics in the past predetermined period. The pressure characteristic information in the present embodiment is information indicating the initial discharge pressure characteristics of the fuel gear pump 400. In this case, the pressure characteristic information may be generated based on the information measured in the inspections and tests that are performed in the initial operation stage such as shipment of the engine, as in the flow rate characteristic information. The deterioration determinator 855 outputs information indicating the determination result in a predetermined mode. For example, the deterioration determinator 855 may record information indicating the determination result in the storage 840, or may output the information indicating the determination result to another device via the communicator 810.

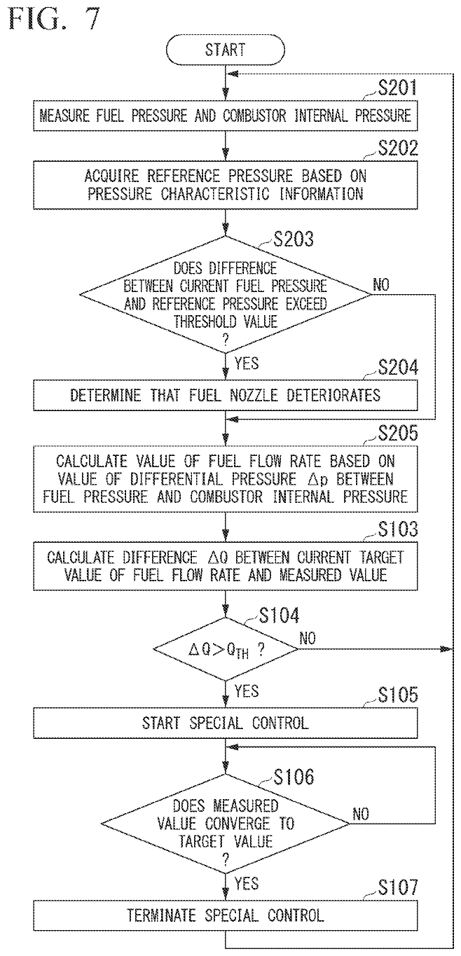

FIG. 7 is a flowchart showing an example of the flow of process related to the special control in the second embodiment. Here, the same processes as those of the special control in the first embodiment are designated by the same reference numerals as those in FIG. 4, and a description thereof will be omitted. Also in FIG. 7, as in FIG. 4, a situation is assumed in which the gas turbine engine is in operation at the start time point of the flow and the discharge flow rate of fuel by the fuel gear pump 400 is controlled by the normal control. In this situation, first, the pressure measurer 853 measures the fuel pressure and the combustor internal pressure based on the output signals of the combustion pressure gauge 210 and the fuel pressure gauge 730 (step S201).

Subsequently, the deterioration determinator 855 acquires the value of the reference pressure assumed for the current rotational speed, based on the pressure characteristic information stored in the storage 840 and the current rotational speed of the electric motor 410 (step S202). Subsequently, the deterioration determinator 855 calculates the difference between the acquired reference pressure value and the measured fuel pressure value, and determines whether the difference value exceeds the second threshold value (step S203). Here, when it is determined that the difference value exceeds the second threshold value, the deterioration determinator 855 determines that the fuel nozzle 600 deteriorates, and outputs information indicating the determination result in a predetermined mode (step S204). On the other hand, when it is determined in step S203 that the difference value does not exceed the second threshold value, the deterioration determinator 855 skips step S204 and proceeds to step S205. Subsequently, the flow rate calculator 854 calculates the flow rate of the fuel that is supplied to the combustor 200B, based on the differential pressure Δp between the fuel pressure and the combustor internal pressure (step S205). After that, steps S103 to S107 related to the special control are executed, using the value calculated in step S205 as the measured value of the fuel flow rate.

The fuel supply system 100B of the second embodiment configured in this way has a configuration that indirectly measures the fuel flow rate by calculation based on the measured values of the fuel pressure and the combustor internal pressure, instead of the direct measurement by the fuel flow meter 720. By providing such a configuration, the fuel supply system 100B of the second embodiment can exhibit the same effect as the fuel supply system 100A of the first embodiment. When the fuel supply system 100B is based on an existing system having measurement function of the fuel pressure and the combustor internal pressure, the system scale can be made smaller than the fuel supply system 100A because the fuel flow meter 720 is not provided. Because the fuel supply system 100B of the second embodiment includes a configuration that measures the fuel pressure, the fuel pressure can be compared with the reference pressure, and it is also possible to determine whether the fuel nozzle 600 has deteriorated.

Although the embodiments for carrying out the present invention have been described above using the embodiments, the present invention is not limited to these embodiments, and various modifications and substitutions can be made within a scope that does not depart from the gist of the present invention.

What is claimed is:

1. A fuel supply system comprising:
a fuel gear pump configured to be driven by an electric motor and to send fuel in a fuel tank to a fuel nozzle that supplies the fuel to a combustor; and
a control device,
wherein the control device includes
a storage device configured to store a program, and
a hardware processor,
wherein the hardware processor executes the program stored in the storage device to
execute a control process of a rotational speed of the electric motor, and
measure a flow rate of the fuel to be discharged from the fuel gear pump, and
when a difference between the fuel flow rate actually discharged from the electric motor and a target value of the flow rate is equal to or greater than a first threshold value with respect to the target value in the control process, a rotational speed of the electric motor is adjusted so that a measured value of the flow rate of the fuel discharged from the fuel gear pump approaches the target value.

2. The fuel supply system according to claim 1, wherein the target value is set for each rotational speed based on past discharge flow rate characteristics of the fuel gear pump, and
the hardware processor acquires the target value of the flow rate with respect to a current rotational speed based on the current rotational speed of the electric motor and flow rate characteristic information indicating the past discharge flow rate characteristics.

3. The fuel supply system according to claim 1, wherein the hardware processor measures a fuel pressure, which is a pressure on an upstream side of the fuel nozzle in a fuel supply line, and measures a combustor internal pressure, which is a pressure inside the combustor, and
the hardware processor calculates the flow rate of the fuel discharged from the fuel gear pump, based on a difference between the fuel pressure and the combustor internal pressure.

4. The fuel supply system according to claim 1, wherein when a differential pressure between a current fuel pressure and a past fuel pressure is equal to or greater than a second threshold value, the hardware processor determines that the fuel nozzle has deteriorated.

5. The fuel supply system according to claim 4, wherein the hardware processor acquires a value of the past fuel pressure, based on the current rotational speed of the electric motor and pressure characteristic information indicating a relationship between the rotational speed of the electric motor and the discharge pressure in the past.

6. The fuel supply system according to claim 1, wherein the hardware processor measures the flow rate of the fuel, by a flow meter installed on the upstream side of a manifold configured to send the fuel discharged from the fuel gear pump to each of the fuel nozzles in a fuel supply line.

7. A fuel supply method of sending fuel in a fuel tank to a fuel nozzle configured to supply the fuel to a combustor by a fuel gear pump,
wherein an electric motor drives the fuel gear pump,
a control device measures a flow rate of the fuel discharged from the fuel gear pump, and
when a difference between the fuel flow rate actually discharged from the electric motor and a target value of the flow rate is equal to or greater than a first threshold value with respect to the target value, the control device adjusts a rotational speed of the electric motor so that a measured value of the flow rate of the fuel discharged from the fuel gear pump approaches the target value.
